(19) United States
(12) Patent Application Publication
(10) Pub. No.: US 2024/0330021 A1
(43) Pub. Date: Oct. 3, 2024

(54) CONTEXTUAL USER INTERFACE COMPONENT

(71) Applicant: Capital One Services, LLC, McLean, VA (US)

(72) Inventors: Daniel DOMINGUEZ, Adisson, TX (US); Mia FREDERICK, The Colony, TX (US); Alexis PRITCHARD, Dallas, TX (US); Chengwei LIM, McKinney, TX (US); Preetha VEERARAGHAVAN, Plano, TX (US)

(73) Assignee: Capital One Services, LLC, McLean, VA (US)

(21) Appl. No.: 18/130,151

(22) Filed: Apr. 3, 2023

(51) Int. Cl. G06F 9/451; H04L 41/22; H04L 67/02

(52) U.S. Cl. CPC G06F 9/451; H04L 41/22; H04L 67/02

(57) ABSTRACT

A system, method and computer program product for providing a contextual user interface (UI) component is provided. Responsive to a first context, the system renders a first view of the contextual UI component by loading a first registry associated with the first context and composing the first view from a first set of UI components identified thereby. Responsive to a second context, the system renders a second view of the contextual UI component by loading a second registry associated with the second context and composing the second view from a second set of UI components identified thereby. Each of the UI components included in the contextual UI component may be a reusable UI component, a micro frontend, or a nested contextual UI component. The system maintains state for the contextual UI component that persists across the first and second contexts should a context switch occur.

### BACKGROUND

Across many organizations, software development teams build large, complex software applications to meet customer needs. Often, the size and complexity of these applications necessitate multiple teams working on the same application. When a software application is developed by multiple teams working on the same monolithic code base, the required coordination renders software development complex and difficult to manage, lengthening the development lifecycle. To address this issue, some software applications are decomposed into smaller components, which may be referred to as micro-applications, each of which may be developed substantially independently of the other and in parallel and then integrated together into a final product. This approach can beneficially reduce complexity and significantly shorten the development life cycle.

In the context of web applications, a micro-application may comprise a micro frontend (MFE) that is configured to execute on a client computing device (e.g., in a web browser) and a corresponding backend for frontend (BFF) that is configured to execute on one or more servers. Even in a scenario where the development of a web application entails the parallel development of multiple micro-applications, it can still be difficult to add a new micro-application to the web application because the client-side code for generating and maintaining the UI must be carefully modified to incorporate the corresponding new MFE. Furthermore, removing or reordering MFEs will also require modifying such code. Testing, such as A/B testing, which may be based on adding, removing and/or reordering MFEs, will also be difficult to perform since the code for generating and maintaining the UI must be updated to generate each version of the UI to be tested

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are system, apparatus, device, method and/or computer program product embodiments, and/or combinations and sub-combinations thereof for providing a contextual UI component.

In an embodiment, a method for providing a contextual UI component is performed by code executing in a web browser. The method includes determining a first context and, in response to determining the first context: loading into the web browser a first UI component framework associated with the first context, the first UI component framework comprising a plurality of slots; loading into the web browser a first UI component registry associated with the first context, the first UI component registry identifying a plurality of UI components; composing a first view of the contextual UI component by inserting each one of the UI components identified by the first UI component registry in a corresponding slot within the first UI component framework; and rendering the first view of the contextual UI component to a window of the web browser.

In further accordance with such an embodiment, the method may further comprise determining that the first context has switched to a second context and, in response to determining that the first context has switched to the second context: loading into the web browser a second UI component framework associated with the second context, the second UI component framework comprising a plurality of slots; loading into the web browser a second UI component registry associated with the second context, the second UI component registry identifying a plurality of UI components; composing a second view of the contextual UI component by inserting each one of the UI components identified by the second UI component registry in a corresponding slot within the second UI component framework; and rendering the second view of the contextual UI component to the window of the web browser.

In still further accordance with such an embodiment, the method may further comprise maintaining state for the contextual UI component that persists from the first context to the second context.

In an embodiment, a non-transitory computer readable medium includes instructions for causing a processor to perform operations for providing a contextual UI component. The operations include determining a first context and, in response to determining the first context: loading into a web browser a first UI component registry associated with the first context, the first component registry identifying a plurality of UI components; composing a first view of the contextual UI component by inserting each one of the UI components identified by the first UI component registry in a corresponding slot within a first UI component framework; and rendering the first view of the contextual UI component to a window of the web browser.

In further accordance with such an embodiment, the operations may further comprise determining that the first context has switched to a second context and, in response to determining that the first context has switched to the second context: loading into the web browser a second UI component registry associated with the second context, the second component registry identifying a plurality of UI components; composing a second view of the contextual UI component by inserting each one of the UI components identified by the second UI component registry in a corresponding slot within a second UI component framework; and rendering the second view of the contextual UI component to the window of the web browser.

In still further accordance with such an embodiment, the operations may further comprise maintaining state for the contextual UI component that persists from the first context to the second context.

In an embodiment, a computing system for providing a contextual UI component comprises a display, a storage unit configured to store instructions, and a control unit that is coupled to the storage unit and the display. The control unit is configured to process the stored instructions to: responsive to determining a first context, render a first view of a contextual UI component to the display by loading a first UI component registry associated with the first context and composing the first view of the contextual UI component from a first set of UI components identified by the first UI component registry; and responsive to determining a second context, render a second view of the contextual UI component to the display by loading a second UI component registry associated with the second context and composing the second view of the contextual UI component from a second set of UI components identified by the second UI component registry.

In further accordance with such an embodiment, the control unit may be further configured to process the stored instructions to maintain state for the contextual UI component that persists across the first and second contexts.

Further features and advantages of embodiments, as well as the structure and operation of various embodiments, are described in detail below with reference to the accompanying drawings. It is noted that the methods, systems and computer program products are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings are incorporated herein and form a part of the specification.

FIG. 1 is a block diagram of a system for providing a contextual UI component for a web application in accordance with an embodiment.

FIG. 2 is a block diagram of various client-side components of a system for providing a contextual UI component for a web application in accordance with an embodiment.

FIG. 3 is a block diagram showing the structure and operation of a container that is loaded into a web browser and that operates to compose and render a contextual UI component for a web application in accordance with an embodiment.

FIG. 4 depict a flowchart of a method for providing a contextual UI component for a web application in accordance with an embodiment.

FIG. 5 depicts a flowchart of a further method for providing a contextual UI component for a web application in accordance with an embodiment.

FIG. 6 illustrates an exemplary computer system for implementing some aspects of the disclosure or portion(s) thereof.

In the drawings, reference numbers generally indicate identical or similar elements. Additionally, generally, the left-most digit(s) of a reference number identifies the drawing in which the reference number first appears.

### DETAILED DESCRIPTION

Provided herein are a method, a system, computer program product embodiments, and/or combinations and sub-combinations thereof for providing a contextual UI component.

As noted in the Background section above, the size and complexity of certain software applications may necessitate that multiple teams work to develop the same application. When a software application is developed by multiple teams working on the same monolithic code base, the required coordination renders software development complex and difficult to manage, lengthening the development lifecycle. To address this issue, some software applications are decomposed into smaller components, which may be referred to as micro-applications, each of which may be developed substantially independently of the other and in parallel and then integrated together into a final product. This approach can beneficially reduce complexity and significantly shorten the development life cycle.

In the context of web applications, a micro-application may comprise a micro frontend (MFE) that is configured to execute on a client computing device (e.g., in a web browser) and a corresponding backend for frontend (BFF) that is configured to execute on one or more servers. Even in a scenario where the development of a web application entails the parallel development of multiple micro-applications, it can still be difficult to add a new micro-application to the web application because the client-side code for rendering and maintaining the UI must be carefully modified to incorporate the corresponding new MFE. Furthermore, removing or reordering MFEs will also require modifying such code. Testing, such as A/B testing, which may be based on adding, removing and/or reordering MFEs, will also be difficult to perform since the code for rendering and maintaining the UI must be updated to generate each version of the UI to be tested.

As will be described herein, a system, method and computer program product for providing a contextual UI can be used to address these issues. In particular, embodiments described herein utilize a predefined UI component framework and a configurable registry of UI components (e.g., MFEs, reusable UI components, and/or nested contextual UI components) that can be loaded at runtime to generate the contextual UI component, as well as a shell component that maintains state for all the UI components that make up the contextual UI component. Such embodiments make it easier to add features to the contextual UI component. For example, a developer may add a feature to the contextual UI component by simply adding a reference to a new MFE in the registry of UI components and specifying an associated slot in the UI component framework in which the MFE should be inserted. Thus, such embodiments make the contextual UI component easily scalable.

The registry of UI components can likewise be modified to remove features from the contextual UI component (e.g., by removing a reference to an MFE from the registry), or to rearrange (e.g., reorder) the UI components that make up the contextual UI component. Since embodiments described herein make it much easier to add, remove or rearrange features of the contextual UI component, such embodiments also make it easier to generate different versions of the contextual UI component for testing, such as for A/B testing.

Further, since embodiments described herein enable a contextual UI component to be modified by simply editing a UI component registry as opposed to modifying the client-side code that generates and maintains the contextual UI component, such embodiments facilitate reuse of the client-side code to implement numerous different variants of the contextual UI component.

In embodiments, it may be desired to add, remove or rearrange features of a UI component of a web application at runtime in response to a particular context or change of context. For example, it may be desired to provide a first set of features to a user determined to be in a first location and a second set of features to a user determined to be in second location. Likewise, it may be desired to provide a first set of features to one type of user (e.g., a user determined to be pre-approved for a loan, a trusted user, an administrator) and a second set of features to another type of user (e.g., a user determined not to be pre-approved for a loan, an untrusted user, a non-administrator). As yet another example, it may be desired to present different variants of the same UI component to different users or user populations for the purposes of conducting A/B testing. Numerous other examples may be contemplated.

One approach to enabling such functionality would be to, prior to the determination of the context and the presentation of the UI component, download code to the user's web browser that is capable of generating and maintaining both context-specific views of the UI component. However, this approach could negatively impact the performance of the web application and the associated user experience since downloading so much code at once may cause the web application to stall.

Embodiments described herein address this issue by downloading to the web browser a shell component that determines the relevant context and then, based on the determination, downloads the components necessary to provide the appropriate context-specific view of the contextual UI component. The shell component may also determine when there is a switch to a new context and, based on that determination, download the components necessary to provide the new appropriate context-specific view of the contextual UI component.

In embodiments, the shell component also advantageously maintains a globalized state for the contextual UI component and all the sub-components thereof (e.g., MFEs, reusable UI components, nested contextual UI components) and this state is persisted across contexts. Thus, state can remain persistent throughout the entire user experience and be shared among different context-specific UI components.

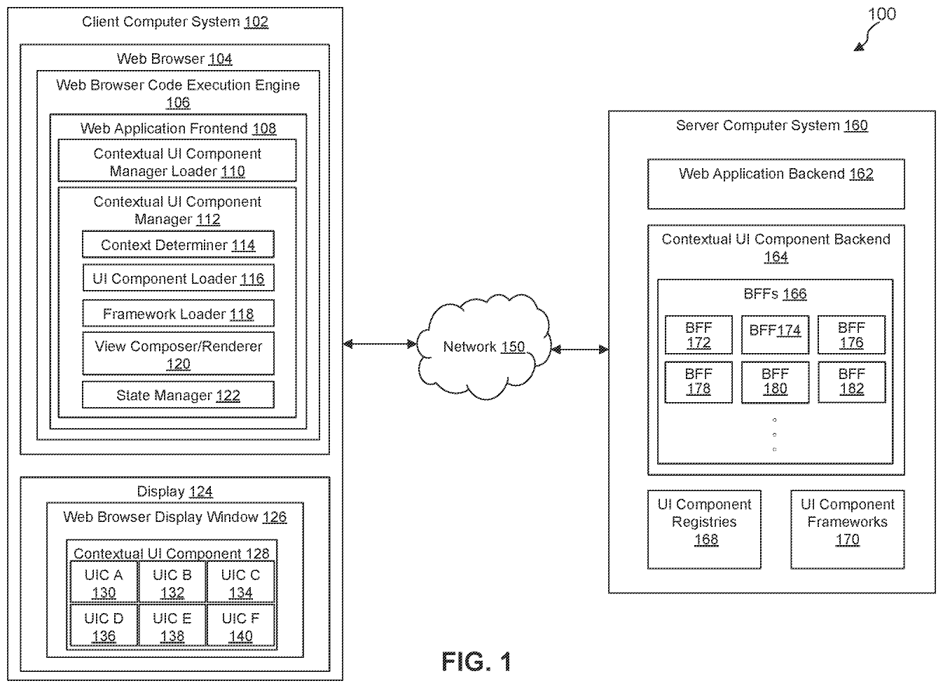

To further illustrate the foregoing, reference is now made to FIG. 1, which is a block diagram of a system 100 for providing a contextual UI component for a web application in accordance with an exemplary embodiment. As shown in FIG. 1, system 100 includes a client computer system 102, a server computer system 160, and a network 150 that communicatively connects client computer system 102 and server computer system 160.

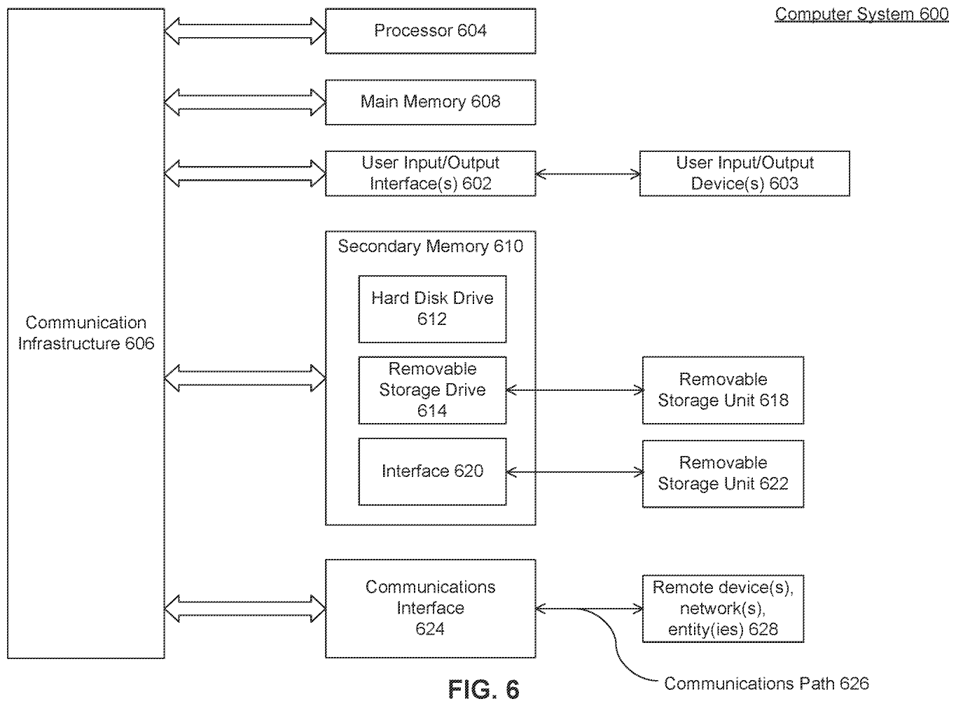

Client computer system 102 is intended to broadly represent any computer system suitable for performing functions that are ascribed thereto in the following description, as will be appreciated by persons skilled in the relevant art(s). One example of such a computer system will be described below in reference to FIG. 6. Client computer system 102 may be embodied in a device with at least one integrated display such as a smart phone, a laptop computer, a notebook computer, a tablet computer, a netbook, an all-in-one desktop computer, a handheld video game console, a smart television, a wearable device (e.g., smart watch, virtual/augmented reality headset), or the like. Client computer system 102 may also be implemented by a device, such as a desktop computer, video game console, or set-top box, that is connected to a suitable display device. However, these are merely examples and are not intended to be limiting.

Server computer system 160 is intended to broadly represent any computer system suitable for performing functions that are ascribed thereto in the following description, as will be appreciated by persons skilled in the relevant art(s). One example of such a computer system will be described below in reference to FIG. 6. Server computer system 160 may be implemented by one or more on-premise servers, one or more cloud-based servers, or as a combination of on-premise and cloud-based servers. However, these are merely examples and are not intended to be limiting.

Network 150 may be any communication network suitable for facilitating the exchange of electronic and/or digital communications between client computer system 102 and server computer system 160. In embodiments, network 150 comprise one or more of a local area network (LAN), a wide area network (WAN), a virtual private network (VPN), or a public switched telephone network (PSTN), and may encompass wired and/or wireless portions. Additionally, network 150 may employ any of a variety of communication protocols including but not limited to any of Transmission Control Protocol/Internet Protocol (TCP/IP), Secure Sockets Layer (SSL), and/or Hypertext Transfer Protocol (HTTP).

As further shown in FIG. 1, client computer system 102 comprises a web browser 104 and a display 124. Web browser 104 is a software application that is executed by client computer system 102 to enable a user thereof to access resources (e.g., web pages, files) via the World Wide Web. For example, Web browser 104 may be configured to enable a user to navigate (e.g., by specifying a Uniform Resource Locator (URL) or interacting with a HyperText Markup Language (HTML) link) to a web page on the World Wide Web. Although embodiments of the present application will be described with continued reference to web browser 104, it will be appreciated by persons skilled in the relevant art(s) that the operations performed by web browser 104 may also be performed by a variety of different Internet-enabled applications, and thus such embodiments need not be limited to a web-browser-based implementation.

Display 124 represents any display device suitable for rendering graphical or visual content to a user. Web browser 104 is configured to render a web browser display window 126 to display 124. Web browser 104 is further configured to present within web browser display window 126 the content of web pages to which a user has navigated such that the user can view the content and in some cases interact therewith.

Web browser 104 comprises a web browser code execution engine 106. Web browser code execution engine 106 enables web browser 104 to execute code (e.g., JavaScript code) that is embedded in or referenced by a web page to which a user has navigated. In the example shown in FIG. 1, a user has caused web browser 104 to navigate to a web page that provides access to a web application, wherein the web application comprises a web application frontend 108 and a web application backend 162. Web application frontend 108 is loaded into web browser 104 (e.g., from server computer system 160) and is executed by web browser code execution engine 106 to provide a UI for the web application. Web application backend 162 executes on server computer system 160 and is communicatively coupled to web application frontend 108 via network 150. Web application backend 162 may be configured to perform operations in response to user requests made via the UI presented by web application frontend 108 and to return results of those operations to the user via the same UI.

Web application frontend 108 includes a contextual UI component manager loader 110 and a contextual UI component manager 112. Contextual UI component manager loader 110 is configured to load (e.g., from server computer system 160) contextual UI component manager 112 into web browser 104 for execution by web browser code execution engine 106. For example, contextual UI component manager loader 110 may be configured to load contextual UI component manager 112 into web browser 104 by default, in response to a particular user interaction with web application frontend 108, or in response to some other condition, state or context.

Contextual UI component manager 112 is configured to present a contextual UI component 128 to web browser display window 126. Contextual UI component 128 is a UI component that is itself comprised of one or more UI components, wherein the UI component(s) that make up contextual UI component 128 and/or the arrangement (e.g., order) thereof varies depending on a context. For example, as shown in FIG. 1, in accordance with a first context, contextual UI component 128 includes six different UI components (UICs) arranged in a specific order within a framework comprising a 2×3 grid of slots: UI component A 130, UI component B 132, UI component C 134, UI component D 136, UI component E 138, and UI component F 140. However, in accordance with a different context, contextual UI component 128 may comprise a different framework (including but not limited to a different number or arrangement of slots within the framework), a different set of UI components, and/or a different arrangement (e.g., order) of UI components within the slots of the framework.

As noted above, it may be desired to add, remove or rearrange features of a UI component of a web application at runtime in response to a particular context or change of context. As will be discussed herein, contextual UI component manager 112 is configured to achieve this by determining a relevant context and then, based on the determined context, varying one or more of the following aspects of contextual UI component 128: the framework, the set of UI components to be included within the framework, or the arrangement (e.g., order) of UI components within the slots of the framework.

Contextual UI component manager 112 comprises a context determiner 114, a UI component loader 116, a framework loader 118, a view composer/renderer 120 and a state manager 122. Each of these elements will now be described.

Context determiner 114 is configured to determine a context upon which the layout and composition of contextual UI component 128 will be based. In an embodiment, web application frontend 108 passes context information to contextual UI component manager 112 (e.g. as part of an input contract from which contextual UI component manager 112 determines an initial state), and context determiner 114 determines the context based on such context information. However, this example is not intended to be limiting and context determiner 114 may determine the context based on any suitable information provided by or obtained from any suitable source.

UI component loader 116 is configured to load a set of UI components for inclusion within contextual UI component 128, wherein the set of UI components is selected based on the context determined by context determiner 114. In an embodiment, each UI component may comprise one of a MFE, a reusable UI component, or a nested contextual UI component, although these examples are not intended to be limiting. As used herein, the term MFE refers to a UI component that operates in conjunction with a BFF, whereas the term reusable UI component refers to a UI component that isn't supported by a BFF. The set of UI components to be loaded for a particular context is specified by an associated UI component registry. In the embodiment shown in FIG. 1, this registry is stored as part of a set of UI component registries 168 on server computer system 160 and loaded therefrom by UI component loader 116. However, in alternate implementations, the registry may be provided by or retrieved from other sources or systems.

A UI component registry may include an identifier of each UI component to be included in contextual UI component 128. UI component loader 116 may use the identifier of each UI component to retrieve the UI component (e.g., by resolving the identifier to a particular file and/or storage location). Each UI component may be retrieved, for example, from a remote storage location (e.g., within server computer system 160).

The UI component registry may also include, for each UI component identified therein, a flag that indicates whether the UI component is an MFE or not. Such a flag may indicate to UI component loader 116, for example and without limitation, that a MFE-specific loading process should be used to load the UI component and/or that MFE-specific analytics tracking should be enabled for the UI component when it is loaded.

The UI component registry may also include, for each UI component identified therein, an indication of a slot in a UI component framework into which the UI component should be inserted. As an example, this indication may comprise a position in an order in which the UI components are to be inserted into corresponding slots of a UI component framework. As another example, the indication may comprise an identifier of a specific slot within a UI component framework into which the UI component should be inserted. However, these are only a few examples, and any indication that enables a UI component to be mapped to a corresponding slot in the framework may be used.

By way of further illustration, an example UI component registry may include the following information:

```
Components: [
    {
    tag: “component-a”,
    mfe: true,
    order: 1
    },
    {
    tag: “component-b”,
    mfe: false,
    order: 2
    },
    {
    tag: “component-c”,
    mfe: false,
    order: 3
    },
    {
    tag: “component-d”,
    mfe: true,
    order: 4
    }
  ]
```

In accordance with this example, for each UI component in the registry, the value assigned to the “tag” attribute specifies a name of the UI component, the value assigned to the “mfe” attribute specifies whether the UI component is an MFE or not, and the value assigned to the “order” attribute identifies a position in an order in which the UI components are to be inserted into the slots of a corresponding UI component framework.

In an embodiment, a developer may create or edit a UI component registry to identify which UI components should be included in contextual UI component 128 for a specific context, as well as to specify into which slots those UI components should be inserted. As noted above, this aspect of system 100 makes it easy to add, remove and/or rearrange features of contextual UI component 128 with respect to a given context.

Framework loader 118 is configured to load a UI component framework that will be used to construct contextual UI component 128. Like the UI component registry, the UI component framework may be selected based on the context determined by context determiner 114. In an embodiment, the UI component framework is composed of semantic markup and slot elements, wherein each slot element defines a slot within which a UI component may be inserted. In the embodiment shown in FIG. 1, the UI component framework is stored as part of a set of UI component frameworks 170 on server computer system 160 and loaded therefrom by framework loader 118. However, in alternate implementations, the framework may be provided by or retrieved from other sources or systems.

View composer/renderer 120 is configured to compose a view of contextual UI component 128 by inserting each one of the UI components identified by the UI component registry and loaded by UI component loader 116 into a corresponding slot of the UI component framework loaded by framework loader 118. View composer/renderer 120 is further configured to render the view of contextual UI component 128 to web browser display window 126 on display 124. Once rendered in this manner, a user can then view and, depending on the UI component, interact with each of the various UI components that are included within contextual UI component 128.

State manager 122 is configured to maintain a centralized state for contextual UI component 128 and the various UI components that are included therein and to persist such state across contexts. As noted above, this feature enables state to remain persistent throughout the entire user experience and be shared among different context-specific UI components. In one embodiment, state manager 122 is implemented using a version of the REDUX open-source JavaScript library for maintaining and centralizing application state. However, this is merely one example and is not intended to be limiting.

As further shown in FIG. 1, server computer system 160 of system 100 also comprises a contextual UI component backend 164. Contextual UI component backend 164 includes various BFFs 166 that are stored on server computing system 160 and executed thereby. BFFs 166 correspond to the MFEs that may be loaded by UI component loader 116 and inserted into contextual UI component 128. As shown in FIG. 1, such BFFS may include a BFF 172, a BFF 174, a BFF 176, a BFF 178, a BFF 180, and a BFF 182. Each BFF may have an associated application programming interface (API) that can be used by other backend systems (not shown in FIG. 1) to interact therewith. However, in an embodiment, contextual UI component backend 164 provides a unified API by which such other backend systems may interact with the BFFs that support contextual UI component 128. The unified API acts as an abstraction layer that enables such backend systems to obtain data from and provide data and services to contextual UI component 128 in a standardized manner, regardless of the various micro-applications that may be included in the component. For example, the use of the unified API enables micro-applications to be added to contextual UI component 128 without requiring the backend systems that interact with contextual UI component backend 164 to be updated to interact with such micro-applications.

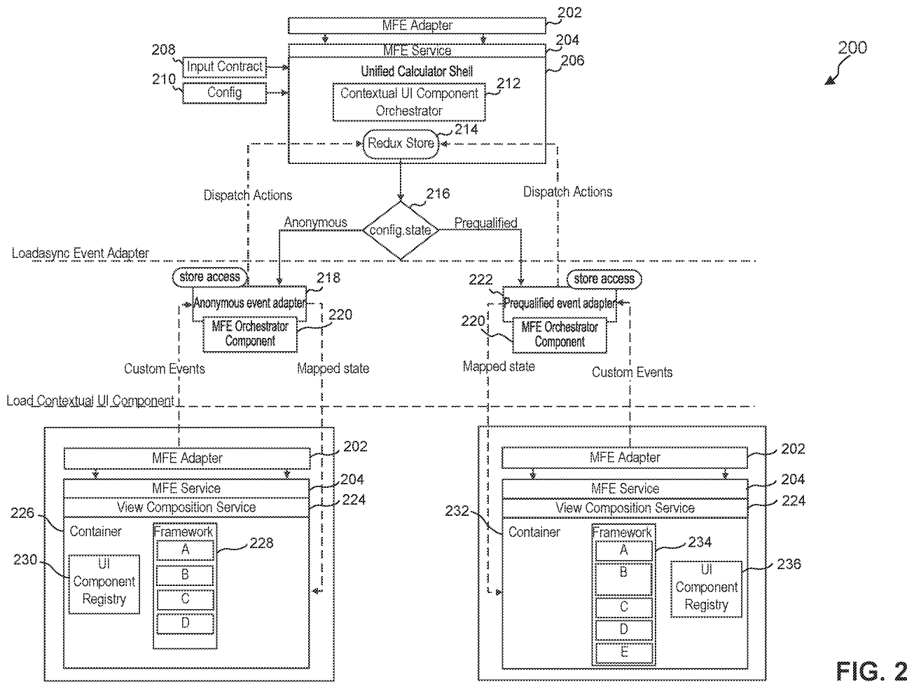

FIG. 2 is a block diagram that illustrates an example implementation 200 of contextual UI component manager 112 of FIG. 1. In the example of FIG. 2, contextual UI component 128 comprises a “unified calculator” that enables a user to obtain cost estimates and potentially secure a loan for purchasing an automobile, wherein the layout and UI components that make up the unified calculator vary depending on whether the user is prequalified for a loan or not.

As shown in FIG. 2, implementation 200 includes a unified calculator shell 206. Unified calculator shell 206 comprises code that is downloaded into web browser 104 by contextual UI component manager loader 110 and executed by web browser code execution engine 106. Contextual UI component manager loader 110 may be configured to load unified calculator shell 206 into web browser 104 by default, in response to a particular user interaction with web application frontend 108, or in response to some other condition, state or context.

Unified calculator shell 206 performs substantially the same functions of state manager 122 and context determiner 114 as described above in reference to FIG. 1. With respect to state management, unified calculator shell 206 utilizes a REDUX store 214 to maintain a globalized state for the unified calculator and the UI components included therein. Upon execution, unified calculator shell 206 receives an input contract 208 from web application frontend 108 that it uses to generate an initial state. Unified calculator shell 206 may also receive (e.g., from web application frontend 108 or some other source) certain configuration parameters 210 that may be used to customize one or more aspects of the unified calculator.

With respect to context determination, unified calculator shell 206 includes a contextual UI component orchestrator 212 that leverages the state information derived from input contract 208 to determine whether the user is not prequalified (i.e., “anonymous”) or prequalified, as represented by decision logic 216. If the user is determined to be anonymous, then contextual UI component orchestrator 212 asynchronously loads into web browser 104 an anonymous event adapter 218 and an MFE orchestrator component 220. However, if the user is determined to be prequalified, then MFE scaffold orchestrator 212 asynchronously loads into web browser 104 a prequalified event adapter 222 and MFE orchestrator component 220. The loading of these elements into web browser 104 is performed by invoking an MFE service 204 which in turn invokes an MFE adapter 202 to perform the necessary operations.

Anonymous event adapter 218 comprises a set of event listeners that are inserted into the Document Object Model (DOM) of the current webpage and operate to respond to custom events generated by the anonymous version of the unified calculator. Prequalified event adapter 222 comprises a set of event listeners that are inserted into the DOM of the current webpage and operate to respond to custom events generated by the prequalified version of the unified calculator. Both event adapters 218, 222 are provided with access to REDUX store 214. This enables the adapters to provide relevant state to each of the UI components that make up the unified calculator and to update the globalized state in response to custom events emanating therefrom.

If anonymous event adapter 218 and MFE orchestrator component 220 are loaded in response to an anonymous user context, then MFE orchestrator component 220 will asynchronously load a view composition service 224 (if not already present in web browser 104) and a container 226. As shown in FIG. 2, container 226 includes a UI component framework 228 associated with the anonymous user context (which in this example includes slots A, B, C and D) and a UI component registry 230 associated with the anonymous user context.

View composition service 224 then composes an anonymous user view of the unified calculator. To achieve this, view composition service 224 loads each of the UI components identified in UI component registry 230 into web browser 104 (if not already present) utilizing MFE service 204 and MFE adapter 202. View composition service 224 then inserts such UI components into UI component framework 228 in a manner similar to that described above in regard to UI component loader 116 and view composer/renderer 120 of FIG. 1. View composition service 224 then renders the anonymous user view of the unified calculator to web browser display window 126 on display 124. Once rendered in this manner, a user can then view and, depending on the UI component, interact with each of the various UI components that are included in the anonymous user view of the unified calculator.

Similarly, if prequalified event adapter 222 and MFE orchestrator component 220 are loaded in response to a prequalified user context, then MFE orchestrator component 220 will asynchronously load view composition service 224 (if not already present in web browser 104) and a container 232. As shown in FIG. 2, container 232 includes a UI component framework 234 associated with the prequalified user context (which in this example includes slots A, B, C, D and E) and a UI component registry 236 associated with the prequalified user context.

View composition service 224 then composes a prequalified user view of the unified calculator. To achieve this, view composition service 224 loads each of the UI components identified in UI component registry 236 into web browser 104 (if not already present) utilizing MFE service 204 and MFE adapter 202. View composition service 224 then inserts such UI components into UI component framework 234 in a manner similar to that described above in regard to UI component loader 116 and view composer/renderer 120 of FIG. 1. View composition service 224 then renders the prequalified user view of the unified calculator to web browser display window 126 on display 124. Once rendered in this manner, a user can then view and, depending on the UI component, interact with each of the various UI components that are included in the prequalified view of the unified calculator.

Example implementation 200 thus first downloads unified calculator shell 206 (which may be a relatively lightweight component) to web browser 104 and then, based on a context determination by unified calculator shell 206, asynchronously downloads the other components necessary to provide the appropriate context-specific view of the unified calculator. This approach to providing a context-specific UI component can deliver superior performance as compared to an approach in which all the elements shown in FIG. 2 are loaded at once. As noted above, the latter approach could negatively impact the performance of web application frontend 108 since downloading so much code at once may cause it to stall.

In further accordance with example implementation 200 of FIG. 2, after one context-specific view of the unified calculator is presented, contextual UI component orchestrator 212 may determine that the context has switched (e.g., an anonymous user has become prequalified). In this scenario, contextual UI component 212 can cause the code elements associated with the presentation of the other context-specific view to be loaded and thereby cause the other context-specific view of the unified calculator to be presented. In this case, unified calculator shell 206 will maintain the globalized state that was established during the first context for potential use and updating during the second context. This ensures that important state information will not be lost but is instead persisted across contexts.

Although example implementation 200 of FIG. 2 shows two possible contexts and two corresponding context-specific views of the unified calculator, persons skilled in the relevant art(s) will appreciate that the systems and methods described herein can be used to identify any number of different contexts and to generate any number of views of a contextual UI component corresponding, respectively, to those contexts.

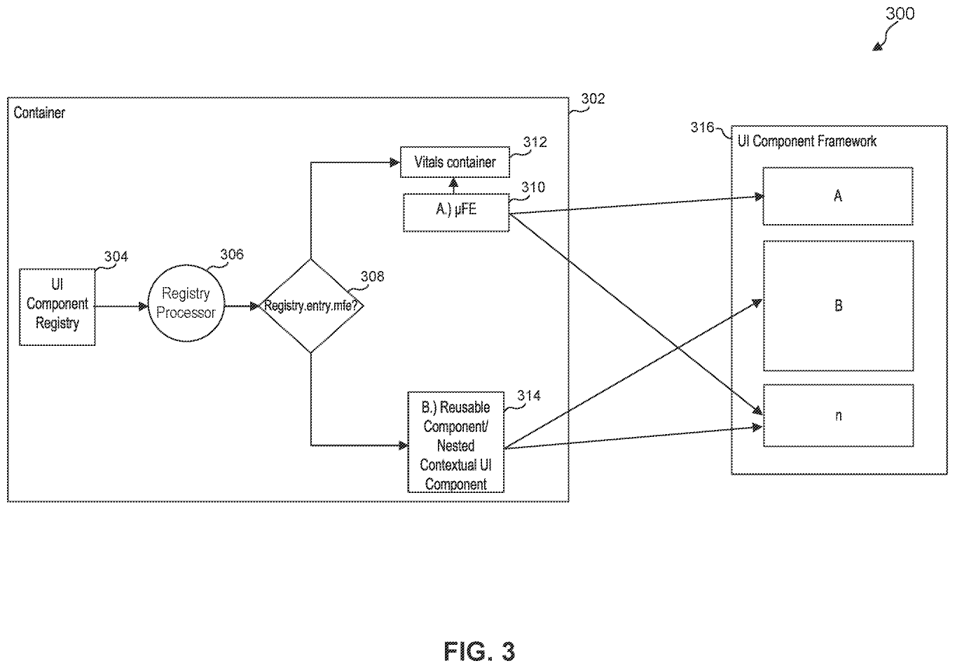

FIG. 3 is a block diagram 300 showing an exemplary structure and operation of a container 302 that is loaded into web browser 104 and that operates to compose and render a contextual UI component for a web application in accordance with an embodiment. Container 302 may represent, for example, either container 226 or container 232 of FIG. 2.

As shown in FIG. 3, container 302 includes a UI component registry 304 and a registry processor 306. Registry processor 306 is configured to process UI component registry 304, which, as noted above, may include an identifier of one or more UI components and, for each identified UI component, a flag that indicates whether the component is an MFE and an indicator that denotes a slot of a UI component framework 316 into which the UI component is to be inserted.

As further shown in FIG. 3, registry processor 306 includes decision logic 308 that reads the flag associated with each UI component identified in UI component registry 304 to determine whether the corresponding UI component is an MFE. If decision logic 308 determines that the UI component is an MFE then registry processor 306 will wrap the relevant MFE 310 in a vitals container 312 which is configured to perform MFE-specific analytics tracking for MFE 310. Registry processor 306 will also insert MFE 310 into a particular slot in UI component framework 316, e.g., based on an information associated with MFE 310 in UI component registry 304.

However, if decision logic 308 determines that the UI component is a non-MFE UI component 314 (e.g., a reusable UI component or a nested contextual UI component), then registry processor 306 will insert non-MFE UI component 314 into a particular slot in UI component framework 316, e.g., based on an information associated with non-MFE component 314 in UI component registry 304.

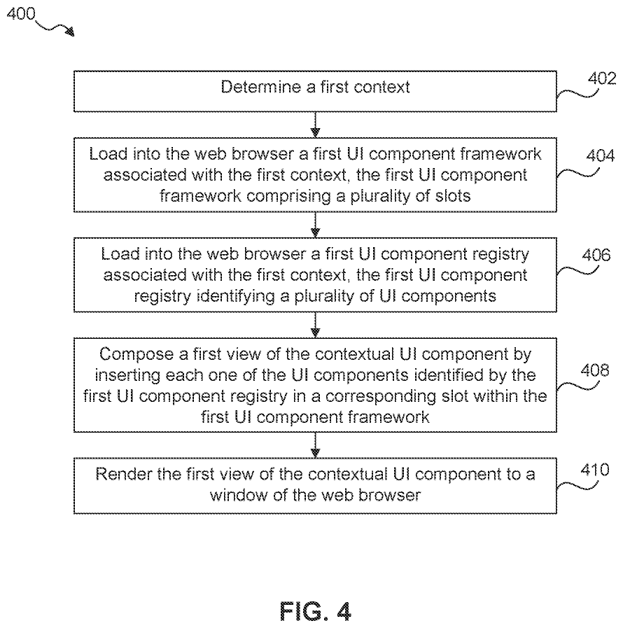

FIG. 4 depicts a flowchart 400 of a method for providing a contextual UI component for a web application in accordance with an embodiment. The method of flowchart 400 may be performed, for example, by contextual UI component manager 112 of FIG. 1 or by example implementation 200 of that component as shown in FIG. 2, each of which is executed in web browser 104. However, the method is not limited to those components.

As shown in FIG. 4, the method of flowchart 400 begins at step 402, in which a first context is determined. This step may be performed, for example, by context determiner 114 of FIG. 1 or contextual UI component orchestrator 212 of FIG. 2. In the case of contextual UI component orchestrator 212 of FIG. 2, the first context will either be “anonymous” or “prequalified”. In response to determining the first context in step 402, steps 404, 406, 408 and 410 may be performed.

In some embodiments, determining the first context may comprise receiving an input contract from a host application executing in the web browser and determining the first context based on the input contract. For example, context determiner 114 or contextual UI component orchestrator 212 may receive an input contract (e.g., input contract 208) from web application frontend 108 and determine the first context based on the input contract.

At step 404, a first UI component framework associated with the first context is loaded into the web browser, wherein the first UI component framework comprises a plurality of slots. This step may be performed, for example, by framework loader 118 of FIG. 1, which may load a first UI component framework associated with the first context from UI component frameworks 170 into web browser 104, or MFE orchestrator component 220 of FIG. 2 which may load one of UI component framework 228 or UI component framework 234 into web browser 104 depending on whether the first context is “anonymous” or “prequalified”.

At step 406, a first UI component registry associated with the first context is loaded into the web browser, wherein the first UI component registry identifies a plurality of UI components. In embodiments, each of the plurality of UI components identified by the first UI component registry may comprise one of an MFE, a reusable UI component, or a nested contextual UI component. Step 406 may be performed, for example, by UI component loader 116 of FIG. 1, which may load the first UI component registry associated with the first context from UI component registries 168 into web browser 104, or MFE orchestrator component 220 of FIG. 2, which may load one of UI component registry 230 or UI component registry 236 into web browser 104 depending on whether the first context is “anonymous” or “prequalified”.

At step 408, a first view of the contextual UI component is composed by inserting each one of the UI components identified by the first UI component registry in a corresponding slot within the first UI component framework. This step may be performed, for example, by view composer/renderer 120 of FIG. 1 which inserts UI components 130, 132, 134, 136, 138 and 140 into the first UI component framework to generate the first view of contextual UI component 128. This step may also be performed by view composition service 224 of FIG. 2, which, depending on whether the first context is “anonymous” or “prequalified”, generates the first view of the unified calculator by either inserting each one of the UI components identified by UI component registry 230 in a corresponding slot within UI component framework 228 or inserting each one of the UI components identified by UI component registry 236 in a corresponding slot within UI component framework 234.

In one embodiment of the method of flowchart 400, the first UI component registry specifies an order for the UI components identified thereby and inserting each one of the UI components identified by the first UI component registry in a corresponding slot within the first UI component framework comprises inserting each one of the UI components identified by the first UI component registry in a corresponding slot within the first UI component framework based on the order.

At step 410, the first view of the contextual UI component is rendered to a window of the web browser. This step may be performed, for example, by view composer/renderer 120 of FIG. 1, which renders the first view of contextual UI component 128 to web browser display window 126 on display 124. This step may also be performed, for example, by view composition service 224 of FIG. 2, which, depending on whether the first context is “anonymous” or “prequalified”, either renders the anonymous user view of the unified calculator or the prequalified user view of the unified calculator to web browser display window 126 on display 124.

In one embodiment of the method of flowchart 400, the method further includes, in response to determining the first context in step 402 and prior to the performance of loading steps 404 and 406, composing step 408, and rendering step 410, loading into the web browser an event adapter associated with the first context and an orchestrator component that loads into the web browser the first UI component framework, the first UI component registry, and a view composition service that performs composing step 408 and rendering step 410. For example, this step may be performed by contextual UI component orchestrator 212 of FIG. 2 which, after determining the context and depending thereon, loads into web browser 104 one of anonymous event adapter 218 or prequalified event adapter 222 as well as MFE orchestrator component 220. As discussed above, MFE orchestrator component 220 loads the appropriate context-specific UI component framework, the appropriate context-specific UI component registry, and view composition service 224 that performs composing step 408 and rendering step 410.

In another embodiment of the method of flowchart 400, the method further includes determining whether each one of the UI components identified by the first UI component registry is a micro frontend and, for each one of the UI components that is determined to be a micro frontend, enabling analytics tracking for the UI component. This step may be performed, for example, by UI component loader 116 of FIG. 1 or view composition service 224 of FIG. 2. As shown in FIG. 3, enabling analytics tracking for an MFE may comprise wrapping the MFE in a vitals container. As also shown in FIG. 3, determining whether each one of the UI components identified by the first UI component registry is a micro frontend may comprise reading a micro frontend flag corresponding to each one of the UI components and included in the first UI component registry.

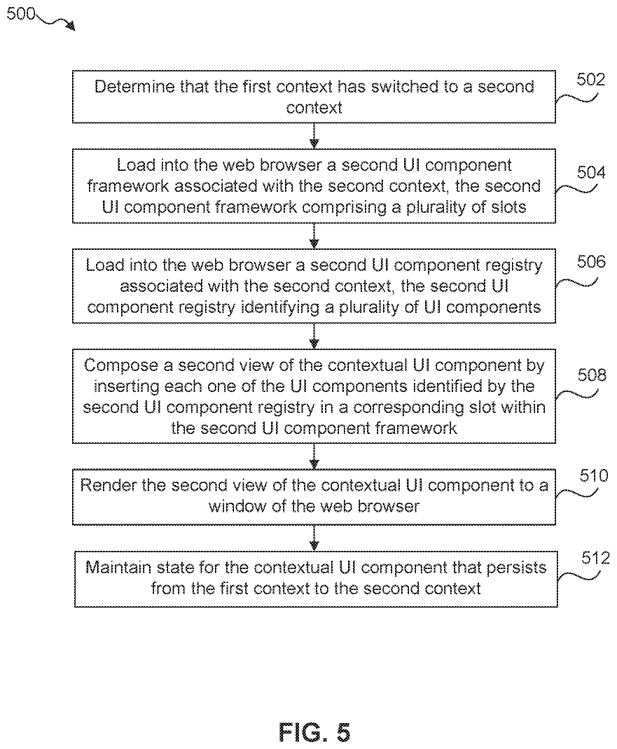

FIG. 5 depicts a flowchart 500 of a further method for providing a contextual UI component for a web application in accordance with an embodiment. The method of flowchart 500 may be performed, for example, by contextual UI component manager 112 of FIG. 1 or by example implementation 200 of that component as shown in FIG. 2, each of which is executed in web browser 104. However, the method is not limited to those components.

As shown in FIG. 5, the method of flowchart 500 begins at step 502, in which it is determined that the first context has switched to the second context. This step may be performed, for example, by context determiner 114 of FIG. 1 or contextual UI component orchestrator 212 of FIG. 2. In the case of contextual UI component orchestrator 212 of FIG. 2, the switch may entail, for example, determining that a user previously determined to be “anonymous” is now determined to be “prequalified”. In response to determining that the first context has switched to the second context in step 502, steps 504, 506, 508, 510 and 512 may be performed.

At step 504, a second UI component framework associated with the second context is loaded into the web browser, wherein the second UI component framework comprises a plurality of slots. This step may be performed, for example, by framework loader 118 of FIG. 1, which may load a second UI component framework associated with the second context from UI component frameworks 170 into web browser 104, or MFE orchestrator component 220 of FIG. 2 which may load UI component framework 234 into web browser 104 (assuming for the sake of this example that the context has switched from “anonymous” to “prequalified”).

At step 506, a second UI component registry associated with the second context is loaded into the web browser, wherein the second UI component registry identifies a plurality of UI components. Step 506 may be performed, for example, by UI component loader 116 of FIG. 1, which may load the second UI component registry associated with the second context from UI component registries 168 into web browser 104, or MFE orchestrator component 220 of FIG. 2, which may load UI component registry 236 into web browser 104 (assuming for the sake of this example that the context has switched form “anonymous” to “prequalified”).

At step 508, a second view of the contextual UI component is composed by inserting each one of the UI components identified by the second UI component registry in a corresponding slot within the second UI component framework. This step may be performed, for example, by view composer/renderer 120 of FIG. 1 which may insert a different set and/or arrangement of UI components than that shown in FIG. 1 into the second UI component framework to generate the second view of contextual UI component 128. This step may also be performed by view composition service 224 of FIG. 2, which, assuming for the sake of this example that the context has switched from “anonymous” to “prequalified”, generates the second view of the unified calculator by inserting each one of the UI components identified by UI component registry 236 in a corresponding slot within UI component framework 234.

At step 510, the second view of the contextual UI component is rendered to a window of the web browser. This step may be performed, for example, by view composer/renderer 120 of FIG. 1, which renders the second view of contextual UI component 128 to web browser display window 126 on display 124. This step may also be performed, for example, by view composition service 224 of FIG. 2, which, assuming for the sake of this example that the context has switched from “anonymous” to “prequalified”, renders the prequalified user view of the unified calculator to web browser display window 126 on display 124.

At step 512, state for the contextual UI component is maintained that persists from the first context to the second context. This step may be performed, for example, by state manager 122 of FIG. 1 or by REDUX store 214 of FIG. 2. As previously noted, this feature enables state to remain persistent throughout the entire user experience and be shared among different context-specific UI components.

FIG. 6 illustrates an exemplary computer system for implementing some aspects of the disclosure or portion(s) thereof.

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A method performed by code executing in a web browser for providing a contextual user interface (UI) component, comprising:
determining a first context; and
in response to determining the first context:
loading into the web browser a first UI component framework associated with the first context, the first UI component framework comprising a plurality of slots;
loading into the web browser a first UI component registry associated with the first context, the first UI component registry identifying a plurality of UI components;
composing a first view of the contextual UI component by inserting each one of the UI components identified by the first UI component registry in a corresponding slot within the first UI component framework; and
rendering the first view of the contextual UI component to a window of the web browser.

2. The method of claim 1, further comprising:
determining that the first context has switched to a second context; and
in response to determining that the first context has switched to the second context:
loading into the web browser a second UI component framework associated with the second context, the second UI component framework comprising a plurality of slots;
loading into the web browser a second UI component registry associated with the second context, the second UI component registry identifying a plurality of UI components;
composing a second view of the contextual UI component by inserting each one of the UI components identified by the second UI component registry in a corresponding slot within the second UI component framework; and
rendering the second view of the contextual UI component to the window of the web browser.

3. The method of claim 2, further comprising:
maintaining state for the contextual UI component that persists from the first context to the second context.

4. The method of claim 1, wherein determining the first context comprises:
receiving an input contract from a host application executing in the web browser; and
determining the first context based on the input contract.

5. The method of claim 1, further comprising:
in response to determining the first context and prior to the performance of the loading, composing, and rendering steps:
loading into the web browser an event adapter associated with the first context and an orchestrator component that loads into the web browser the first UI component framework, the first UI component registry, and a view composition service that performs the composing and rendering steps.

6. The method of claim 1, wherein each of the plurality of UI components comprises one of:
a reusable UI component;
a micro frontend; or
a nested contextual UI component.

7. The method of claim 1, wherein the first UI component registry specifies an order for the UI components identified thereby and wherein inserting each one of the UI components identified by the first UI component registry in a corresponding slot within the first UI component framework comprises:
inserting each one of the UI components identified by the first UI component registry in a corresponding slot within the first UI component framework based on the order.

8. The method of claim 1, further comprising:
determining whether each one of the UI components identified by the first UI component registry is a micro frontend; and
for each one of the UI components that is determined to be a micro frontend:
enabling analytics tracking for the UI component.

9. The method of claim 8, wherein determining whether each one of the UI components identified by the first UI component registry is a micro frontend comprises:
reading a micro frontend flag corresponding to each one of the UI components and included in the first UI component registry.

10. A computing system for providing a contextual user interface (UI) component, comprising:
a display;
a computer readable storage device configured to store instructions;
one or more processors, coupled to the computer readable storage device and the display, that are configured to process the stored instructions to:
responsive to determining a first context, render a first view of a contextual UI component to the display by loading a first UI component framework associated with the first context, the first UI component framework comprising a plurality of slots, loading a first UI component registry associated with the first context, the first UI component registry identifying a first set of UI components, and composing the first view of the contextual UI component by inserting each UI component in the first set of UI components identified by the first UI component registry in a corresponding slot within the first UI component framework; and
responsive to determining a second context, render a second view of the contextual UI component to the display by loading a second UI component framework associated with the second context, the second UI component framework comprising a plurality of slots, loading a second UI component registry associated with the second context, the second UI component registry identifying a second set of UI components, and composing the second view of the contextual UI component by inserting each UI component in the second set of UI components identified by the second UI component registry in a corresponding slot within the second UI component framework.

11. The computing system of claim 10, wherein the one or more processors are further configured to process the stored instructions to:
maintain state for the contextual UI component that persists across the first and second contexts.

12. (canceled)

13. The computing system of claim 10:
wherein the first UI component registry specifies an order for the first set of UI components and wherein inserting each UI component in the first set of UI components in a corresponding slot of the first UI component framework comprises inserting each UI component in the first set of UI components in a corresponding slot of the first UI component framework based on the order for the first set of UI components; and
wherein the second UI component registry specifies an order for the second set of UI components and wherein inserting each UI component in the second set of UI components in a corresponding slot of the second UI component framework comprises inserting each UI component in the second set of UI components in a corresponding slot of the second UI component framework based on the order for the second set of UI components.

14. The computing system of claim 10, wherein the one or more processors are further configured to process the stored instructions to:
determine the first context or the second context based on an input contract received from a host application.

15. The computing system of claim 10, wherein the one or more processors are configured to process the stored instructions to:
render the first view of the contextual UI component to the display by loading an event adapter associated with the first context and an orchestrator component that loads at least the first UI component framework and the first UI component registry; and
render the second view of the contextual UI component to the display by loading an event adapter associated with the second context and an orchestrator component that loads at least the second UI component framework and the second UI component registry.

16. The computing system of claim 10, wherein each UI component in the first set of UI components and the second set of UI components comprises one of:
a reusable UI component;
a micro frontend; or
a nested contextual UI component.

17. A non-transitory computer readable medium including instructions for causing a processor to perform operations for providing a contextual user interface (UI) component, the operations comprising:
determining a first context; and
in response to determining the first context:
loading into a web browser a first UI component framework associated with the first context, the first UI component framework comprising a plurality of slots;
loading into the web browser a first UI component registry associated with the first context, the first component registry identifying a plurality of UI components;
composing a first view of the contextual UI component by inserting each one of the UI components identified by the first UI component registry in a corresponding slot within the first UI component framework; and
rendering the first view of the contextual UI component to a window of the web browser.

18. The non-transitory computer readable medium of claim 17, wherein the operations further comprise:
determining that the first context has switched to a second context; and
in response to determining that the first context has switched to the second context:
loading into the web browser a second UI component framework associated with the second context, the second UI component framework comprising a plurality of slots;
loading into the web browser a second UI component registry associated with the second context, the second component registry identifying a plurality of UI components;
composing a second view of the contextual UI component by inserting each one of the UI components identified by the second UI component registry in a corresponding slot within the second UI component framework; and
rendering the second view of the contextual UI component to the window of the web browser.

19. The non-transitory computer readable medium of claim 18, wherein the operations further comprise:
maintaining state for the contextual UI component that persists from the first context to the second context.

20. The non-transitory computer readable medium of claim 17, wherein each of the plurality of UI components comprises one of:
a reusable UI component;
a micro frontend; or
a nested contextual UI component.

21. The non-transitory computer readable medium of claim 17, wherein the first UI component registry specifies an order for the first set of UI components and wherein inserting each UI component in the first set of UI components in a corresponding slot of the first UI component framework comprises inserting each UI component in the first set of UI components in a corresponding slot of the first UI component framework based on the order for the first set of UI components.
